(19) United States
(12) Patent Application Publication
(10) Pub. No.: US 2021/0336506 A1
(43) Pub. Date: Oct. 28, 2021

(54) MOTOR

(71) Applicant: LG Electronics Inc., Seoul (KR)

(72) Inventors: Jongsu KIM, Seoul (KR); Taehee KWAK, Seoul (KR); Jungwook MOON, Seoul (KR); Changhum JO, Seoul (KR)

(21) Appl. No.: 17/264,567

(22) PCT Filed: Jun. 21, 2019
(86) PCT No.: PCT/KR2019/007544

§ 371 Date: Jan. 29, 2021

(30) Foreign Application Priority Data
Jul. 31, 2018 (KR) 10-2018-0089404

(51) Int. Cl. H02K 5/20; H02K 9/197

(52) U.S. Cl. CPC H02K 5/203; H02K 9/197

(57) ABSTRACT

The present invention relates to a motor comprising: a motor housing for receiving a stator and a rotor therein; an outer housing detachably coupled to the outside of the motor housing; a first cooling path which is formed inside the outer housing and in which a first cooling fluid flows; a second cooling path which is formed inside the motor housing and in which a second cooling fluid flows to be capable of exchanging heat with the first cooling fluid; and a plurality of spray holes interconnected to one side of the first cooling path and formed to extend through the motor housing toward an inner space of the motor housing from the outer housing to spray the first cooling fluid into the inner space of the motor housing, and thus the present invention allows an oil path housing for oil-cooling to be easily attached to or detached from a water-cooling path housing.

### TECHNICAL FIELD

The present disclosure relates to an electric motor having a combined cooling passage structure of oil cooling and water cooling.

### BACKGROUND

An electric car or vehicle (including hybrid vehicle) having an electric motor as a driving source has been released, which is considered as a future car as it has excellent fuel economy.

In general, an electric motor includes a rotor and a stator, and the rotor may be rotatably provided inside the stator.

The stator has a stator coil wound around the stator core. When a current is applied to the stator coil to rotate the rotor, heat is generated in the stator coil. As such, technologies for cooling the heat generated in the motor have been developed.

In a drive system including a motor of an electric vehicle and an inverter for driving the motor, cooling heat generated in the motor and the inverter plays an important role in size reduction and efficiency improvement of the drive system.

In the conventional motor cooling method or system, an indirect cooling system in which cooling water is circulated in a housing to indirectly cool down the motor, and a direct cooling system in which the motor is directly cooled by injecting or spraying oil onto a stator or a rotor are used.

The direct cooling system has better cooling efficiency and cooling performance than the indirect cooling system. Thus, research and development in the direct cooling system has been actively carried out in recent years.

U.S. Patent Application No. US2004/0163409A1 (hereinafter, “Patent Document 1”, published on Aug. 26, 2004), which is hereby incorporated by reference, discloses a motor cooling structure that cools a motor by individually (or separately) using an oil cooling type or a water cooling type.

In the case of the oil cooling type disclosed in Patent Document 1, an oil cooling passage is installed at a slot of the motor to cover (or surround) an inside and outside of a stator coil axially protruding from a stator core, oil circulated by an oil pump flows along the oil cooling passage so that the oil absorbs heat generated in the stator coil, allowing the motor to be directly cooled.

However, Patent Document 1 has the following problems.

First, attaching the oil cooling passage to an end of the stator core in a manner of covering the stator coil may be difficult.

Second, as a configuration for cooling the motor by driving or operating oil and cooling water systems together is not provided, there is a limitation in satisfying cooling performance when high power of the vehicle is required.

### SUMMARY

The present disclosure describes a (electric) motor that can allow an oil passage for oil cooling to be easily attached and detached to and from a cooling water passage.

The present disclosure also describes a motor that can allow an oil passage housing to be easily assembled to a cooling water passage housing through standardization of the oil passage housing by output and common use of the oil passage housing when a lengthwise size or circumferential size of a housing is increased as a high output of the motor is required.

According to one aspect of the subject matter described in this application, a motor includes a motor housing in which a stator and a rotor are accommodated, an outer housing detachably coupled to an outside of the motor housing, a first cooling passage formed inside the outer housing and configured to allow a first cooling fluid to flow therein, a second cooling passage formed inside the motor housing and configured to allow a second cooling fluid to flow therein so as to enable heat exchange with the first cooling fluid, and a plurality of injection holes communicating with one side of the first cooling passage and formed through the outer housing toward an inner space of the motor housing so as to spray the first cooling fluid into the inner space of the motor housing.

Implementations according to this aspect may include one or more of the following features. For example, the first cooling fluid may be oil, and the second cooling fluid may be cooling water.

In some implementations, the outer housing may be coupled to the motor housing by a plurality of screws.

In some implementations, the outer housing may include a passage body having one side open, provided therein with the first cooling passage and extending along a circumferential direction, and a plurality of fastening portions protruding from both ends of the passage body along the circumferential direction so as to allow the outer housing and the motor housing to be coupled to each other by the plurality of screws.

In some implementations, the outer housing may further include a plurality of extended portions each having the plurality of fastening portions, and extending from the both ends of the passage body toward each other along the circumferential direction.

In some implementations, the plurality of fastening portions may be respectively formed at a front portion and a rear portion of the outer housing in a lengthwise direction thereof.

In some implementations, the motor housing may be provided with a plurality of coupling holes extending in a radial direction, so as allow the plurality of screws to be fastened.

In some implementations, a plurality of inlet ports communicating with the inner space of the motor housing and configured to allow the first cooling fluid to be introduced into another side of the first cooling passage, and a pump unit mounted on an outside of the outer housing and configured to move the first cooling fluid introduced through the plurality of inlet ports into the one side from the another side of the first cooling passage.

In some implementations, the plurality of injection holes may be disposed at an uppermost end inside the outer housing, and the plurality of inlet ports may be disposed at a lowermost end inside the outer housing.

In some implementations, each of the motor housing and the outer housing may be formed as a double wall.

In some implementations, each of the first cooling passage and the second cooling passage may include a plurality of heat exchange cells that extends along a lengthwise direction of the outer housing or the motor housing, a plurality of partition walls that extends along the lengthwise direction of the outer housing or the motor housing and partitions the plurality of heat exchange cells, and a communication hole formed at a front end or a rear end of the plurality of partition walls in a lengthwise direction thereof, so as to allow the plurality of heat exchange cells to communicate with one another in a circumferential direction.

The embodiments of the present disclosure may provide at least one or more of the following benefits.

First, as an outer housing for oil cooling is detachably installed at an outside of a motor housing for water cooling, a motor may be cooled by a motor housing when only water cooling is required, namely, under low speed and low heating conditions.

Further, when both oil cooling and water cooling are required, namely, under high speed and high heating conditions, the motor may be cooled using a combination of oil and water cooling by additionally attaching the outer housing to the motor housing.

Third, when a lengthwise size or circumferential size of the motor housing and the outer housing increase due to an increased output of the motor, the outer housing of various sizes may be used according to an output and a size of the motor through standardization of a size of the outer housing mounted on the motor housing by output or size and through common use of the outer housing.

Fourth, as the outer housing is formed in an arcuate shape to cover a part of the motor housing, and a plurality of fastening portions is formed at both ends of the outer housing, respectively, the motor housing and the outer housing may be coupled by the plurality of fastening portions, allowing an oil passage to be assembled to the motor housing at various angles along a circumferential direction.

Fifth, a structure that enables heat dissipation using a combination of oil and water cooling by providing double passages (or flow paths) in a wall of the motor housing through which cooling water flows and a wall of the outer housing through which oil flows, respectively.

For example, cooling water may cool a stator core and oil while flowing along the inner passage of the motor housing, and then dissipate heat in the radiator to be recirculated to the motor housing.

In addition, cooling oil may be injected into the inner space of the motor housing through a plurality of injection holes to cool the stator coil and the rotor. Then, the cooling oil may emit heat to the cooling water while flowing along the inside of the wall of the outer housing, and may be then recirculated to the inner space of the motor housing.

Further, when the motor is in lower heating and lower output conditions, heat is dissipated by cooling water, and in high heating and high output conditions, heat is dissipated by cooling water and oil using a combination of oil and water cooling.

The combination of oil and water cooling systems (or oil-water cooling complex cooling method) have the following advantages.

The combination of oil and water cooling systems may allow a motor of a higher output to be driven with a housing of the same size when compared with the conventional water cooling system.

Also, dual passages respectively provided in a wall of a motor housing and an outer housing may replace an oil cooler, thereby reducing costs and achieving a compact structure.

In addition, hybrid driving or operation may be available according to an amount (state) of motor heating, thereby increasing cooling efficiency than the conventional oil cooling system in which an oil pump is operated at all times.

Further, as cooling water is only circulated under low heating conditions in which an external temperature is low, a reliability problem due to an increase in oil viscosity at a low temperature may be solved.

Moreover, as a temperature of the motor housing may be reduced by cooling water, a lifespan of a bearing may be increased.

### BRIEF DESCRIPTION OF THE DRAWINGS

FIG. 1 is a perspective view of a drive system according to the present disclosure.

FIG. 2 is a perspective view illustrating a state in which an outer housing is coupled to an outside of a motor housing in FIG. 1.

FIG. 3 is a bottom perspective view of FIG. 2.

FIG. 4 is a front view of FIG. 3.

FIG. 5 is an exploded view of FIG. 2.

FIG. 6 is a schematic view illustrating a first cooling passage formed inside the outer housing in FIG. 3.

FIG. 7 is a cross-sectional view taken along line “VII-VII” of FIG. 1.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the main point of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, it will be understood that when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

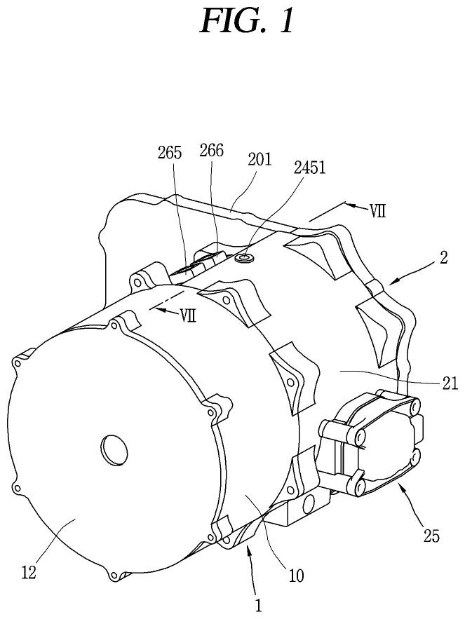

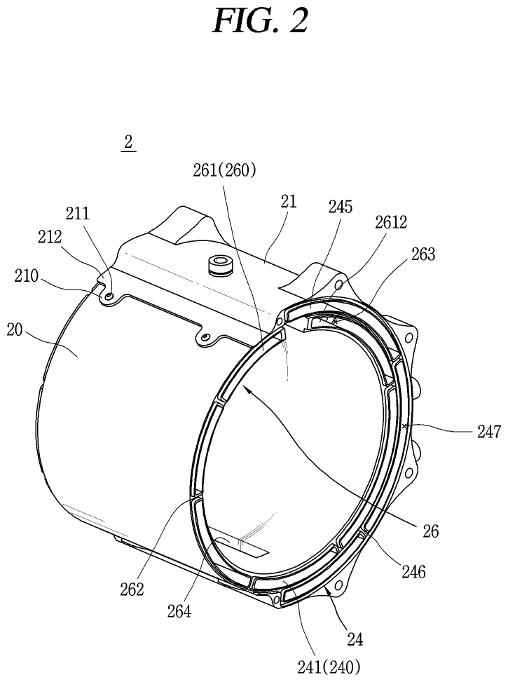

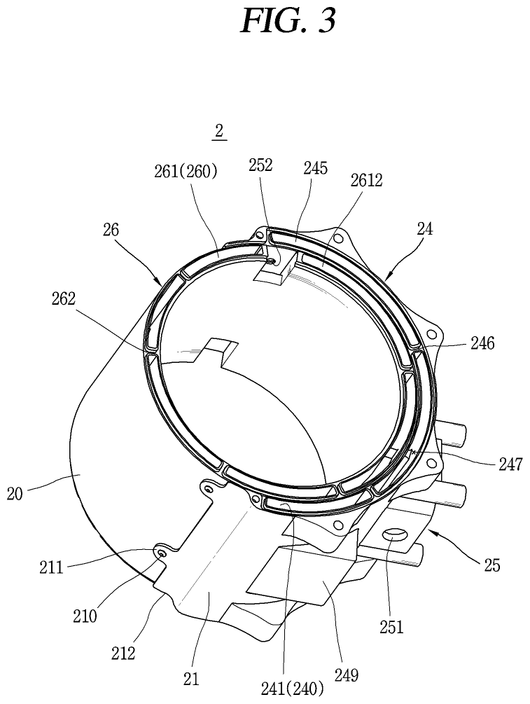

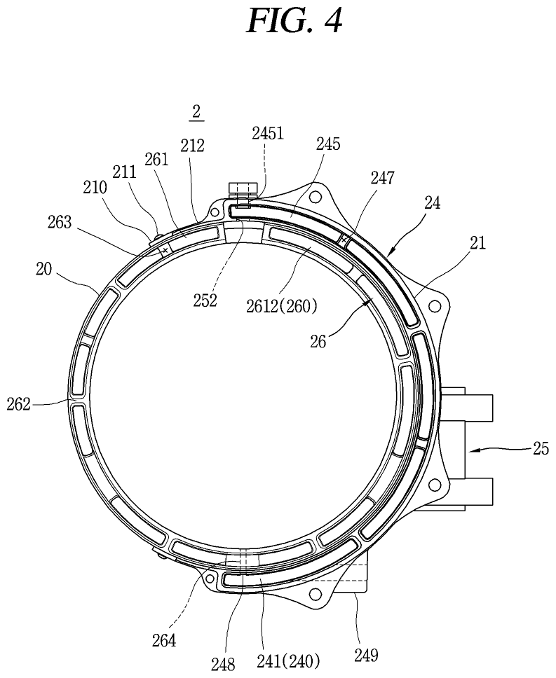

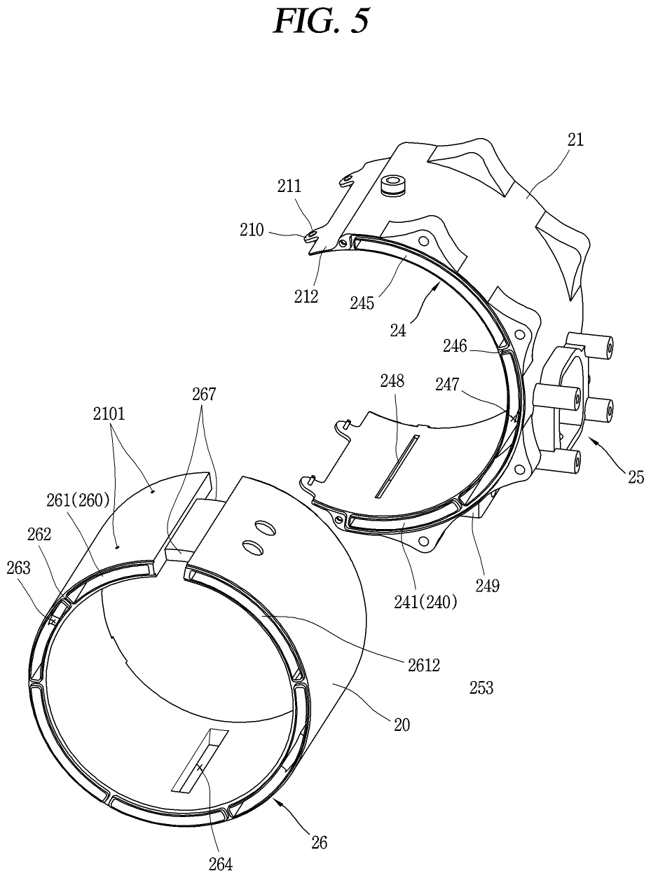

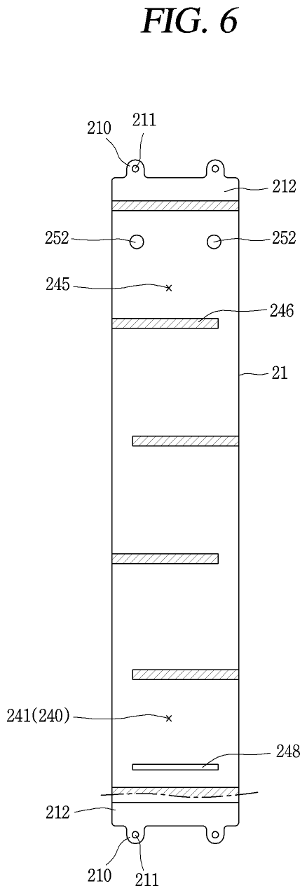

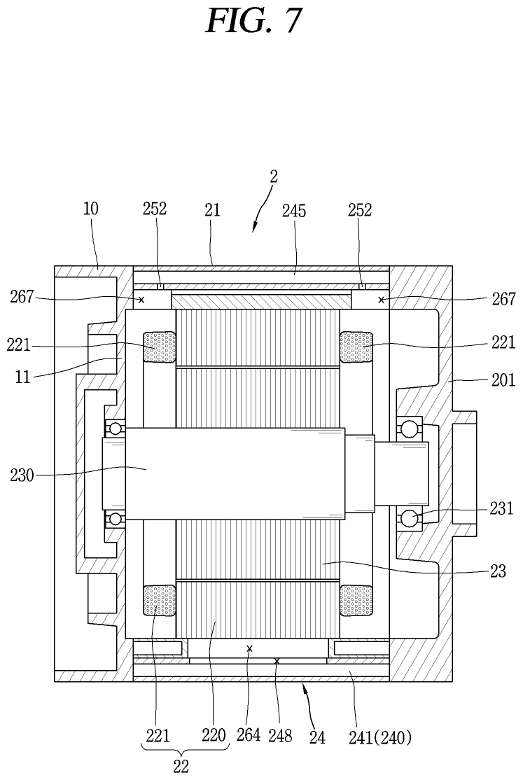

FIG. 1 is a perspective view of a drive system according to the present disclosure, FIG. 2 is a perspective view illustrating a state in which an outer housing 21 is coupled to an outside of a motor housing 20 in FIG. 1, FIG. 3 is a bottom perspective view of FIG. 2, FIG. 4 is a front view of FIG. 3, FIG. 5 is an exploded view of FIG. 2, FIG. 6 is a schematic view illustrating a first cooling passage 24 formed inside the outer housing 21 of FIG. 3, and FIG. 7 is a cross-sectional view taken along line “VII-VII” of FIG. 1.

A drive (or driving) system of the present disclosure having a (electric) motor 2 and an inverter 1 may be applied to an electric vehicle using the motor 2 as a power source. The inverter 1 is a component for driving the motor 2.

The inverter 1 includes an inverter housing 10, and an Insulated Gate Bipolar Transistor (IGBT) and other electronic components or devices may be mounted inside the inverter housing 10.

The motor 2 may include the motor housing 20 in which a stator 22 and a rotor are accommodated.

The stator 22 includes a stator core 220 and a stator coil 221. The stator coil 221 may be wound on a plurality of slots disposed at the stator core 220 to be spaced apart from one another in a circumferential direction.

The rotor may include a rotor core 23, a rotating (or rotational) shaft 230, and a permanent magnet. The rotating shaft 230 may be coupled to an inside of the rotor core 23, so as to be installed to be rotatable together with the rotor core 23.

Both ends of the rotating shaft 230 may be rotatably supported by a plurality of bearings 231. One of the plurality of bearings 231 may be mounted on a rear cover 201, and the other one may be mounted on a back cover 11 of the inverter housing 10.

When electric power is applied to the stator coil 221, a magnetic field is formed around the stator coil 221. As the rotor rotates with respect to the stator 22 by electromagnetic interaction between the rotor and the stator 22, power may be generated.

The motor housing 20 may be formed in a cylindrical shape. Both sides of the motor housing 20 may be open in a lengthwise direction. The rear cover 201 may be coupled to a rear end of the motor housing 20 so as to cover a rear part (or side) of the motor housing 20.

Electronic devices may be accommodated in the inverter housing 10, and the inverter housing 10 may be coupled to a front end of the motor housing 20.

The inverter housing 10 may have a cylindrical shape, and one side thereof is open in its lengthwise direction and another side thereof is closed. The back cover 11 provided at the another side of the inverter housing 10 may extend in a radial direction so as to cover the another side of the inverter housing 10. The back cover 11 may also cover the open front end of the motor housing 20.

A front cover 12 may be coupled to one side of the inverter housing 10 so as to cover the one open side of the inverter housing 10.

The front cover 12, the inverter housing 10, the motor housing 20, and the rear cover 201 are disposed to extend along an axial direction. A plurality of coupling portions may extend radially outward from the front cover 12, a plurality of coupling portions may radially extend from front and rear ends of the inverter housing 10, a plurality of coupling portions may radially extend from the front end and rear ends of the motor housing 20, and a plurality of coupling portions may extend radially outward from the rear cover 201.

Fastening members such as a bolt may penetrate through the respective coupling portions of the front cover 12, the inverter housing 10, the motor housing 20, and the rear cover 201.

In order to cool the motor 2, a combination of oil and water cooling systems (methods) that use oil as a first cooling fluid and cooling water as a second cooling fluid may be applied.

The outer housing 21 may be detachably mounted to an outside of the motor housing 20.

The outer housing 21 may be installed to cover at least a part of a circumferential surface of the motor housing 20. The outer housing 21 may be formed in an arcuate shape. The outer housing 21 may extend along the circumferential direction so as to surround a semi-circumference of the motor housing 20.

The rear housing 21 may be greater (or longer) than the semi-circumference of the motor housing 20. The outer housing 21, although not shown in the drawings, may be less (or shorter) than the semi-circumference of the motor housing 20.

The outer housing 21 may be formed such that a section of one side is open along the circumferential direction, and both ends of the outer housing 21 have elasticity, allowing the outer housing 21 to be stretched radially outward or be compressed radially inward. The motor housing 20 may be inserted radially inward through the open portion of the outer housing 21 to be coupled to the motor housing 20.

The outer housing 21 may be provided with a plurality of fastening portions 210 formed at both ends thereof so as to be coupled to the motor housing 20. The plurality of fastening portions 210 may protrude from the both ends of the outer housing 21 in the circumferential direction. The plurality of fastening portions 210 may be disposed to be spaced apart from each other in a lengthwise direction of the outer housing 21.

One of the plurality of fastening portions 210 may be disposed at a front part of the outer housing 21, and the other fastening portion 210 may be disposed at a rear part of the outer housing 21.

A coupling hole 2101 may be formed through each of the plurality of fastening portions 210 in a thickness direction, allowing the plurality of fastening portions 210 and the motor housing 20 to be coupled to each other by the fastening member 211 such as a screw.

The outer housing 21 may further include a plurality of extended portions 21. The plurality of extended portions 212 may extend from the both ends of the outer housing 21 along the circumferential direction, so as to be connected to the plurality of fastening portions 210, respectively. The plurality of extended portions 212 may be disposed on the same circumference as an inner circumferential surface of the outer housing 21 with 180 degrees or greater apart along the inner circumferential surface of the outer housing 21.

The plurality of extended portions 212 may extend to a thickness the same as a plate thickness of an inner circumferential wall of the outer housing 21 and allow the outer housing 21 and the plurality of fastening portions 210 to be integrally connected to each other.

The plurality of fastening portions 210 may protrude from one end of the extended portion 212 along the circumferential direction to have the same thickness as the extended portion 212. The plurality of fastening portions 210 may be formed in a band shape. Each of the plurality of fastening portions 210 may have an end with a semi-circular shape.

The outer housing 21 may be formed as a double wall (structure). The first cooling passage 24 may be provided between two walls of the double wall of the outer housing 21. The first cooling passage 24 may be formed between a first wall located radially outward of the outer housing 21 and a second wall located radially inward thereof, allowing oil to flow in the circumferential direction.

The first cooling passage 24 may include a plurality of heat exchange cells 240, a plurality of partition walls 246, and a plurality of communication holes 247.

The plurality of heat exchange cells 240 may be spaced apart from one another in a circumferential direction of the outer housing 21. Each of the plurality of heat exchange cells 240 may extend along the lengthwise direction of the outer housing 21.

The plurality of partition walls 246 may extend along the lengthwise direction of the outer housing 21 and disposed between two heat exchange cells 240 located adjacent to each other in the circumferential direction, allowing the plurality of heat exchange cells 240 to be spaced apart from one another along the circumferential direction.

The plurality of communication holes 247 may be formed at a front end or a rear end of the respective partition walls 246, so that the plurality of heat exchange cells 240 communicate with each other in a zigzag manner along the circumferential direction.

The plurality of partition walls 246 may guide oil, which is the first cooling fluid, to flow along the lengthwise direction of the outer housing 21, and the plurality of communication holes 247 may guide oil between two heat exchange cells 240 located adjacent to each other in the circumferential direction to flow in the circumferential direction.

The plurality of communication holes 247 may be alternately disposed at the front end or the rear end of the respective partition walls 246 while moving in a counterclockwise direction of the outer housing 21.

The plurality of heat exchange cells 240 may include a first heat exchange cell 241, a second heat exchange cell 242, a third heat exchange cell 243, a fourth heat exchange cell 244, and a fifth heat exchange cell 245. The first heat exchange cell 241 may be located at the lowermost end of the outer housing 21, and the fifth heat exchange cell 245 may be located at the uppermost end of the outer housing 21.

The first to fifth heat exchange cells 241 to 245 may be disposed to be spaced apart from each other from a lower end to an upper end of the outer housing 21 in counterclockwise order. An oil injection port 2451 may be formed at the fifth heat exchange cell 245. An oil plug (or stopper) may be coupled to the oil injection port 2451 so as to allow the oil injection port 2451 to be opened and closed.

An oil inlet port 248 may be formed at a bottom surface of the outer housing 21. The oil inlet port 248 formed as a long slot may penetrate through the outer housing 21 in its lengthwise direction to communicate with the first heat exchange cell 241. The oil inlet port 248 may be provided at a bottom surface of the second wall.

An intake (or suction) part 249 may extend in a tangential direction from an outside of the first heat exchange cell 241. The intake part 249 is configured such that oil introduced in the first heat exchange cell 241 is sucked into an oil pump 25, which is a pump unit. A suction hole may be formed inside the intake part 249. One side of the suction hole may communicate with a first wall of the first heat exchange cell 241 and another side thereof may communicate with an outside of the outer housing 21, so as to be connected to the oil pump 25 by a connecting member such as an elbow-shaped connecting hose.

The oil pump 25 may be mounted on an outer surface of the outer housing 21. The oil pump 25 may be disposed in a range between the second heat exchange cell 242 and the third heat exchange cell 243. The oil pump 25 may include a pump blade rotatably installed so as to allow a fluid to be sucked into a pump housing, a pump motor that rotates the pump blade, and a motor shaft that connects the pump blade and the pump motor.

An oil intake port 251 may be formed on a bottom surface of the pump housing. The oil intake port 251 may be connected to the suction hole of the intake part 249 by a connection hose (not shown), so that oil may be sucked into the oil pump 25 from the first heat exchange cell 241.

An oil outlet hole may be formed in a mounting portion 253 to which the oil pump 25 is mounted in a direction that faces the second heat exchange cell 242. As the oil outlet hole is formed through a first wall of the second heat exchange cell 240, the oil pump 25 and the second heat exchange cell 242 may communicate with each other, allowing pumped oil to be discharged to the second heat exchange cell 242 from the oil pump 25.

The oil discharged to the second heat exchange cell 242 may flow to the third heat exchange cell 243, the fourth heat exchange cell 244, and the fifth heat exchange cell 245 in a zigzag manner along the circumferential direction.

A plurality of oil injection (or spray) holes 252 may be formed in a second wall of the fifth heat exchange cell 245. One of the plurality of oil injection holes 252 may be disposed at the front part of the outer housing 21, and the other one may be disposed at the rear part of the outer housing 21.

The stator coil 221 may include end coils axially protruding from the slots of the stator core 220. The plurality of oil injection holes 252 may inject or spray oil introduced into the fifth heat exchange cell 245 directly onto the stator coil 221. The plurality of oil injection holes 252 may spray oil onto the end coils.

Heat generated in the stator coil 221 may be cooled by the sprayed oil.

While oil flows from the first heat exchange cell 241 to the fifth heat exchange cell 245, heat may be released or emitted to cooling water through heat exchange with the cooling water.

Cooling water may be configured to flow along a second cooling passage 26 formed in the motor housing 20. The second cooling passage 26 may be cooled by a cooling water circulation system disposed at an outside of the motor 2.

The cooling water circulation system may include a radiator installed at an inner front side of the vehicle, a cooling water circulation line that connects the radiator and the second cooling passage 26 of the electric motor 2, and a water pump installed at the cooling water circulation line.

A cooling water inlet port 265 and a cooling water outlet port 266 may be formed at the outside of the motor housing 20, the cooling water inlet port 265 and the cooling water outlet port 266 may be connected to the cooling water circulation line, and cooling water may be circulated from the second cooling passage 26 to the radiator by power received from the water pump.

Referring to FIG. 1, the cooling water inlet port 265 and the cooling water outlet port 266 may be spaced apart from each other on the same straight line along a lengthwise direction of the motor housing 20, or the cooling water inlet port 265 and the cooling water outlet port 266 may be spaced apart from each other in a circumferential direction and the lengthwise direction of the motor housing 20.

The radiator may be configured to emit heat of cooling water through air introduced into the front of the vehicle. Cooling water may emit heat absorbed from oil through the radiator, and may be then introduced again into the second cooling passage 26 through the cooling water inlet port 265.

The cooling water may absorb heat from oil while flowing along the second cooling passage 26, and may be then discharged to the cooling water circulation line through the cooling water outlet port 266.

The motor housing 20 may be formed as a double wall. The double wall of the motor housing 20 may have a first wall located radially outward thereof and a second wall disposed radially inward thereof. The second cooling passage 26 may be formed between the first wall and the second wall of the motor housing 20.

The first wall and the second wall of the outer housing 21 may be in surface contact while facing each other in the radial direction.

The second cooling passage 26 may include a plurality of heat exchange cells 260, a plurality of partition walls 262, and a plurality of communication holes 263.

The plurality of heat exchange cells 260 may include first to twelfth heat exchange cells 2601 to 2612 arranged in counterclockwise order. Each of the plurality of heat exchange cells 240 may extend in the lengthwise direction of the motor housing 20.

The plurality of heat exchange cells 240 may be spaced apart from one another in the circumferential direction.

The plurality of partition walls 262 may extend in the lengthwise direction of the motor housing 20. The plurality of partition walls 262 may be disposed between two heat exchange cells 260 located adjacent to each other in the circumferential direction, allowing the plurality of heat exchange cells 260 to be spaced apart from one another in the circumferential direction.

The plurality of communication holes 263 may be respectively formed at a front end or a rear end of the plurality of partition walls 262 in a lengthwise direction thereof. The plurality of communication holes 263 may be spaced apart from one another in the circumferential direction. Parts (some) of the plurality of communication holes 263 may be provided at the respective front ends of the odd-numbered partition walls 262 disposed to be spaced apart from one another in counterclockwise order, namely, a first partition wall 262, a third partition wall 262, a fifth partition wall 262, a seventh partition wall 262, a ninth partition wall 262, and an eleventh partition wall 262, and another parts of the plurality of communication holes 263 may be formed at the respective rear ends of the even-numbered partition walls 262, namely, a second partition wall 262, a fourth partition wall 262, a sixth partition wall 262, an eighth partition wall 262, a tenth partition wall 262, and a twelfth partition wall 262.

The plurality of partition walls 262 may have different widths in the circumferential direction. For example, the fifth partition wall 262, the seventh partition wall 262 located at the lowermost end of the motor housing 20, the ninth partition wall 262, and the twelfth partition wall 262 located at the uppermost end of the motor housing 20 may have a wider circumferential width than other partition walls 262.

Among the plurality of heat exchange cells 260, the twelfth partition wall 262 may be disposed between the first heat exchange cell 2601 and the twelfth heat exchange cell 2612 that are located at the uppermost end of the motor housing 20. A recess portion 267 recessed in a forward and backward direction may be provided at a front end and a rear end of the twelfth partition wall 262.

The plurality of coupling holes 2101 may be respectively formed on the first partition wall 262 and the sixth partition wall 262 of the motor housing 20 to be spaced apart from each other in the forward and backward direction.

Each of the plurality of injection holes 252 may be disposed at an upper part of the recess portion 267, so that oil injected through the injection holes 252 may pass through an inner space of the recess portion 267 to be sprayed onto the stator coil 221.

Among the plurality of heat exchange cells 260, the seventh partition wall 262 may be disposed between the seventh heat exchange cell 2607 and the eighth heat exchange cell 2608 that are located at the lowermost end of the motor housing 20. An oil inlet hole 264 may be formed in the seventh partition wall 262. The oil inlet hole 264 may extend in the lengthwise direction of the motor housing 20.

An upper side of the oil inlet hole 264 may communicate with the inner space of the motor housing 20, and a lower side of the oil inlet hole 264 may communicate with the oil inlet port 248 of the outer housing 21.

With this configuration, the motor housing 20 may serve as a housing for water cooling, and the outer housing 21 may serve as a passage (or flow path) module for oil cooling. When water cooling is only required, namely, under low speed and low heating conditions, the motor 2 may be cooled only by the motor housing 20.

Further, when both oil cooling and water cooling are required, namely, under high speed and high heating conditions, the motor 2 may be cooled using a combination of oil and water cooling by additionally attaching the outer housing 21 to the motor housing 20.

When a lengthwise size or circumferential size of the motor housing 20 and the outer housing 21 increase due to an increased output of the motor, the outer housing 21 of various sizes may be used according to an output and a size of the motor through standardization of a size of the outer housing 21 mounted on the motor housing 20 by output or size and through common use of the outer housing 21.

An oil passage attached to the motor housing 20 may also be configured to be assembled at various angles along the circumferential direction besides description of the embodiment.

According to the present disclosure, a structure that enables heat dissipation using a combination of oil and water cooling by providing double passages (or flow paths) in the wall of the motor housing 20 through which cooling water flows and the wall of the outer housing 21 through which oil flows, respectively.

For example, cooling water may cool the stator core 220 and oil while flowing along the inner passage of the motor housing 20, and dissipate heat in the radiator to be recirculated to the motor housing 20.

In addition, cooling oil may be injected into the inner space of the motor housing 20 through a plurality of injection holes to cool the stator coil 221 and the rotor. Then, the cooling oil may emit heat to the cooling water while flowing along the inside of the wall of the outer housing 21, and may be then recirculated to the inner space of the motor housing 20.

Further, when the motor 2 is in lower heating and lower output conditions, heat is dissipated by cooling water, and in high heating and high output conditions, heat is dissipated by cooling water and oil using a combination of oil and water cooling.

The combination of oil and water cooling systems have the following advantages.

First, the combination of oil and water cooling systems may allow a motor of a higher output to be driven with a housing of the same size when compared with the conventional water cooling system.

Second, the dual passages provided in the wall of the motor housing 20 and the outer housing 21 may replace an oil cooler, thereby reducing costs and achieving a compact structure.

Third, hybrid driving or operation may be available according to an amount (state) of motor heating, thereby increasing cooling efficiency than the conventional oil cooling system in which the oil pump 25 is operated at all times.

Fourth, as cooling water is only circulated under low heating conditions in which an external temperature is low, a reliability problem due to an increase in oil viscosity at a low temperature may be solved.

Fifth, as a temperature of the motor housing 20 may be reduced by cooling water, a lifespan of a bearing may be increased.

1. A motor, comprising:
a motor housing that accommodates a stator and a rotor therein;
an outer housing coupled to an outside of the motor housing;
a first cooling passage defined inside the outer housing and configured to guide a first cooling fluid; and
a second cooling passage defined inside the motor housing and configured to guide a second cooling fluid to thereby exchange heat exchange with the first cooling fluid,
wherein the outer housing defines a plurality of injection holes that are in communication with the first cooling passage and connected to an inner space of the motor housing, the plurality of injection holes being configured to spray the first cooling fluid into the inner space of the motor housing.

2. The motor of claim 1, wherein the first cooling fluid comprises oil, and the second cooling fluid comprises water.

3. The motor of claim 1, wherein the outer housing is coupled to the motor housing by a plurality of screws.

4. The motor of claim 3, wherein the outer housing comprises:
a passage body that has an open side and defines the first cooling passage, the passage body extending along a circumferential direction of the outer housing; and
a plurality of fastening portions that extend from ends of the passage body along the circumferential direction and receive the plurality of screws.

5. The motor of claim 4, wherein the outer housing further comprises a plurality of extended portions that include the plurality of fastening portions and extend from the ends of the passage body toward each other along the circumferential direction.

6. The motor of claim 4, wherein the plurality of fastening portions are disposed at a front portion of the outer housing and a rear portion of the outer housing in a lengthwise direction of the outer housing.

7. The motor of claim 3, wherein the motor housing defines a plurality of coupling holes that receive the plurality of screws inserted in a radial direction.

8. The motor of claim 1, wherein the outer housing further defines a plurality of inlet ports that are in communication with the inner space of the motor housing and configured to introduce the first cooling fluid to one side of the first cooling passage, and
wherein the motor further comprises a pump unit mounted on an outside of the outer housing and configured to cause the first cooling fluid introduced through the plurality of inlet ports to move to another side of the first cooling passage.

9. The motor of claim 8, wherein the plurality of injection holes are defined at a first end of the outer housing, and the plurality of inlet ports are defined at a second end of the outer housing opposite to the first end.

10. The motor of claim 1, wherein each of the motor housing and the outer housing includes a double wall.

11. The motor of claim 1, wherein each of the first cooling passage and the second cooling passage comprises:
a plurality of heat exchange cells that extend along a lengthwise direction of the motor housing; and
a plurality of partition walls that extend along the lengthwise direction and partition each of the first cooling passage and the second cooling passage into the plurality of heat exchange cells, each partition wall defining a communication hole at an end configured to communicate with the plurality of heat exchange cells in a circumferential direction of the motor housing.

12. An electric motor, comprising:
a motor housing that accommodates a stator and a rotor therein;
an outer housing that covers a part of the motor housing and is coupled to an outside of the motor housing;
a first cooling passage defined inside a wall of the outer housing and configured to guide a first cooling fluid, the first cooling passage penetrating through the outer housing in a lengthwise direction; and
a second cooling passage defined inside the motor housing and configured to guide a second cooling fluid to thereby exchange heat with the first cooling fluid, the second cooling passage penetrating through the motor housing in the lengthwise direction.

13. The electric motor of claim 12, wherein the first cooling passage comprises:
a plurality of heat exchange cells that extend along the lengthwise direction and are configured to guide the first cooling fluid; and
a plurality of partition walls that extend along the lengthwise direction and partition the first cooling passage into the plurality of heat exchange cells, the plurality of partition walls being spaced part from one another in a circumferential direction,
wherein the plurality of partition walls define communication holes that are each in communication with adjacent heat exchange cells among the plurality of heat exchange cells, and
wherein the communication holes are alternately arranged at a front end of one partition wall among the plurality of partition walls and a rear end of another partition wall adjacent to the one partition wall to thereby guide the first cooling fluid through the plurality of heat exchange cells along a zigzag direction and the circumferential direction.

14. The electric motor of claim 12, wherein the second cooling passage comprises:
a plurality of heat exchange cells that extend along the lengthwise direction and configured to guide the second cooling fluid; and
a plurality of partition walls that extend along the lengthwise direction and partition the second cooling passage into the plurality of heat exchange cells, the plurality of partition walls being spaced part from one another in a circumferential direction,
wherein the plurality of partition walls define communication holes that are in communication with adjacent heat exchange cells among the plurality of heat exchange cells, and
wherein the communication holes are alternately arranged at a front end of one partition wall among the plurality of partition walls and a rear end of another partition wall adjacent to the one partition wall to thereby guide the second cooling fluid through the plurality of heat exchange cells along a zigzag direction and the circumferential direction.

15. The electric motor of claim 12, further comprising:
a rear cover that covers open rear ends of the motor housing and the outer housing; and
an inverter housing that covers open front ends of the motor housing and the outer housing.

16. The electric motor of claim 12, wherein the outer housing has a semi-cylindrical shape and surrounds a portion of an outer circumferential surface of the motor housing.

17. The electric motor of claim 12, wherein the outer housing comprises a first heat exchange cell located at a first end of the outer housing, and a second heat exchange cell located at a second end of the outer housing opposite to the first end,
wherein the motor housing defines an oil inlet hole in communication with an inner space of the motor housing, the oil inlet hole being configured to supply the first cooling fluid into the first heat exchange cell,
wherein the outer housing defines:
an oil inlet port that is in communication with the oil inlet hole and configured to receive the first cooling fluid,
a plurality of injection holes that connect the second heat exchange cell to the motor housing and configured to spray the first cooling fluid into the inner space of the motor housing, and
wherein the electric motor further comprises an oil pump configured to cause the first cooling fluid to move from the first heat exchange cell to the second heat exchange cell.

18. The electric motor of claim 17, wherein the motor housing defines a recess portion recessed from an end of the motor housing in a radial direction, the recessed portion being configured to receive the first cooling fluid sprayed through the plurality of injection holes.

19. The electric motor of claim 12, wherein the motor housing further defines:
a cooling water inlet port configured to communicate with an upstream side of the second cooling passage and to introduce the second cooling fluid to the second cooling passage; and
a cooling water outlet port configured to communicate with a downstream side of the second cooling passage and to discharge the second cooling fluid from the second cooling passage.

20. The electric motor of claim 12, wherein the outer housing comprises a plurality of fastening portions that protrude from ends of the outer housing and are coupled to the motor housing, each of the plurality of fastening portions defining a coupling hole.
